(19) United States
(12) Patent Application Publication
(10) Pub. No.: US 2005/0039027 A1
(43) Pub. Date: Feb. 17, 2005

(54) Universal, biometric, self-authenticating identity computer having multiple communication ports

(76) Inventor: Michael F. Shapiro, Tampa, FL (US)

Correspondence Address: HOLLAND & KNIGHT LLP, ATTN: STEFAN V. STEIN/ IP DEPT., POST OFFICE BOX 1288, TAMPA, FL, 33601-1288, US

(21) Appl. No.: 10/628,282

(22) Filed: Jul. 25, 2003

(51) Int. Cl. H04K 1/00

(52) U.S. Cl. 713/186

(57) ABSTRACT

An improved device for use in authorizing transactions and performing applications is provided by the present invention. The device uses a local processor and secure data storage in conjunction with a variety of sensors to perform authentication processes that establish an individual's identity and provide authority to perform a desired transaction. The sensors allow the device to directly scan biometric identifying information from an individual. A card swipe interface and a proximity antenna are provided to facilitate communication between the device and remote interface devices such as magnetic swipe card readers, smart card readers, infrared communications ports and proximity and long range radio scanners. In addition, the local processor, memory, display and user inputs allow the device to run applications such as those performed by a traditional computer, gaming device or personal data assistant.

### FIELD OF THE INVENTION

The present invention relates generally to the field of smart identification systems. More particularly, the present invention relates to a smart identification device that uses biometric sensors, in conjunction with independent on-device processing, memory, communications ports and power, to provide a personalized, self-authenticating, self-contained, multiple purpose, identification and application computer.

### BACKGROUND

Identification cards are widely used to establish an individual's identity and, thus, allow the individual to access a particular type of account or service. Typically, the identification card consists of a picture and a set of data associated with the pictured individual. To make an identification, an authority figure reviews the image and data on the identification card and makes the identification decision based upon their visual observations. However, this type of identification suffers from a number of well known drawbacks. For example, images are easily produced using modern copiers and color printers and a fake visual form of identification can inexpensively be produced. Furthermore, the actual affirmative identification most often depends upon the judgment and competence of the individual making the visual comparison. Therefore, such an identification system is never more reliable than the least reliable individual administering the system. Finally, updating the information contained on such a card typically requires producing a new card and obtaining the individual's consent to the update.

Personal data assistants (PDAs) are computer controlled devices that let individuals run various applications. These applications often include calculators, e-mail, daily planners, alarms, games, etc. Although PDAs are popular, widely used devices, they are unable to perform truly secure transactions or affirmatively identify their users. In addition, PDA's are not equipped to easily communicate with devices such as credit card machines, magnetic swipe card readers, proximity detectors, etc.

In light of the above discussed deficiencies in the prior art, what is needed is an improved form of identification that is difficult to counterfeit, communicates with other electronic devices, is easy to update and is self-authenticating.

### SUMMARY OF THE INVENTION

A preferred embodiment of the present invention is directed toward a hand-held device for authenticating an individual's identity and authorizing physical access or use of limited access accounts. The hand-held device includes a magnetic strip that is readable by a standard swipe card reader and a power supply for providing power to the device. Magnetic strip writing means are provided that allow a processor to alter information contained on the magnetic strip. A keyboard allows the entry of text into the device. Input communication means receive a request for an authentication signal from a remote terminal. In response to the received request for an authentication signal or a manual activation by a user, a biometric sensor detects biometric information and produces a sensed biometric profile. A biometric profile corresponding to an individual is contained in a memory on the hand-held device. The memory also contains certification information that can be examined by a remote terminal to determine if the device corresponds to an authorized account. The processor compares the sensed biometric profile with the stored biometric profile and produces an authentication signal. In a preferred embodiment, the biometric sensor is a fingerprint detector and the processor and memory include fingerprint recognition software for determining if a sensed fingerprint matches a stored profile. In alternative embodiments using a variety or combination of biometric sensors, the biometric sensor may be a microphone that receives audible signals and voice recognition software that compares the audible signals with stored individual audio profiles or a camera that captures an image of the user's iris or facial geometry and comparison software that matches the images with stored profiles of the individual. Output communication means communicate the authentication signal to the remote terminal. In a most preferred embodiment, the output communication means is a radio frequency transceiver and proximity antenna for sending and receiving messages from a proximity detector. However, in alternative embodiments, the output communication means could include an infrared communication port, a serial or USB communication port or other wired or wireless communication channels. A speaker is also provided that allows the processor to produce audible indications and outputs.

Another embodiment of the present invention is directed toward an electronic data assistant. A display and a keyboard are used to communicate with a user of the electronic data assistant. The electronic data assistant has a card swipe interface that allows stored data to be communicated to a magnetic stripe card reader. The electronic data assistant also includes an internal memory that can be modified by the processor and a read only memory that cannot be modified by the processor. Applications such as games, calculators, calendars, e-mail are stored in the memory and run by the processor. A data input allows the electronic data assistant to receive personal identifying data from a remote source. In one embodiment, the data input is a fingerprint sensor that produces a fingerprint profile as personal identifying data in response to an individual placing their finger against the fingerprint sensor. In another embodiment, the data input is a microphone that produces an electronic data signal in response to received audio signals and voice recognition software processes the electronic data signal to produce the personal identifying data. The memory stores personal identification information related to a particular individual and the processor compares the personal identifying data to the stored personal identification information. An authentication signal is produced based upon the comparison. A data output communicates the authentication signal to a remote source.

Yet another embodiment of the present invention is directed toward a method of authorizing an individual to access an account or perform a transaction with a portable, hand-held electronic device. In accordance with the method, a communication center's request for an identification is detected with the hand-held device. A user of the hand-held electronic device is then prompted to respond to the request for an identification by providing biometric information such as a fingerprint or voice sample to the hand-held device. The biometric information is received from the user with the hand-held electronic device. The biometric information is then processed with the hand-held electronic device to determine if the biometric information corresponds to an individual biometric profile stored in the hand-held device. An authentication signal is produced with the hand-held electronic device and the authentication signal is communicated from the hand-held electronic device to the communication center in response to receiving the request for an identification.

The above-discussed embodiments of the present invention provide a number of advantages over the prior art. By providing an on-device memory and processor, the invention allows credible identifications to be obtained without any reliance upon human judgment or integrity. In addition, the storing of the biometric profile information on the device itself restricts access to the personal information and eliminates the need to compile large databases of this personal information. Registration certificates and segmented, limited access memory on the device also insure that the personal data stored on the device is not modified by unauthorized users. The provision of the processor, display and data inputs on the identification device or token allow personal computing functions such as scheduling, calculating and running application software to be incorporated into the identification device. The ability to communicate with a variety of different types of devices in a variety of different formats increases the utility of the device by allowing it to perform a number functions typically performed by separate devices. Therefore, the present invention represents a substantial improvement upon the prior art.

### BRIEF DESCRIPTION OF THE DRAWINGS

FIG. 1 is a functional diagram of a preferred embodiment of the present invention;

FIG. 2 is a flow chart of a registration procedure utilized by a preferred embodiment of the present invention;

FIG. 3 is a flow chart of an authentication procedure utilized by a preferred embodiment of the present invention;

FIG. 4 is a flow chart of a transaction/application procedure utilized by a preferred embodiment of the present invention;

FIG. 5 is a pictorial representation of an external housing for an embodiment of the present invention; and

FIG. 6 is a pictorial representation of an external housing for another embodiment of the present invention.

### DETAILED DESCRIPTION OF THE INVENTION

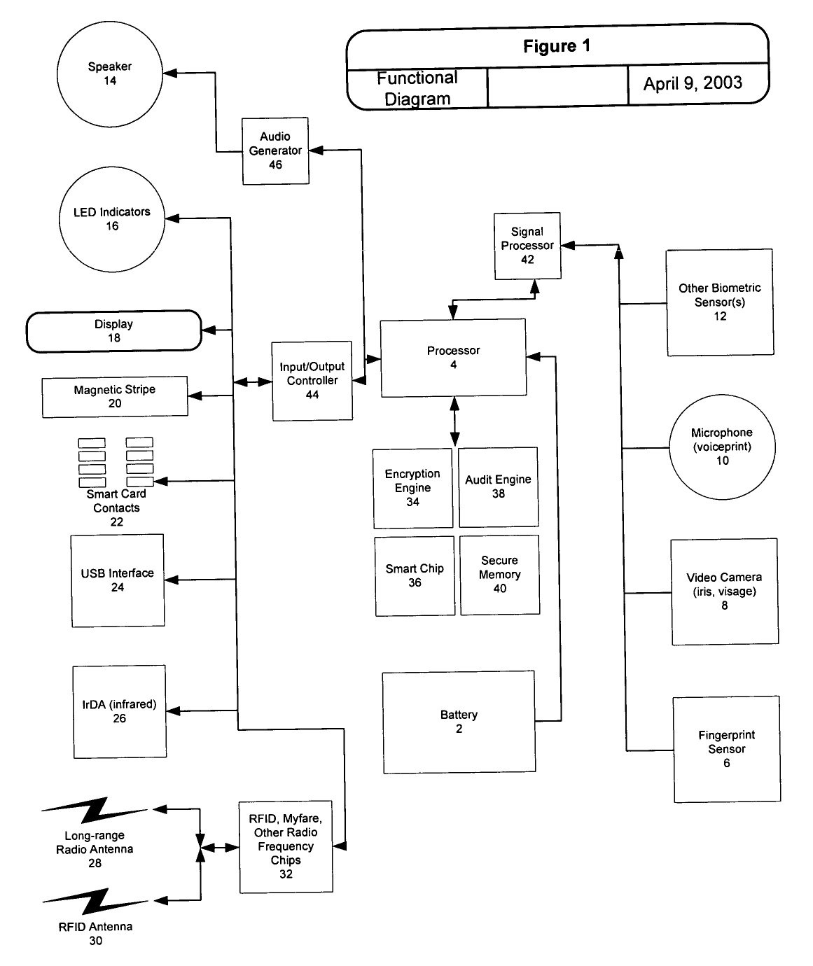

Referring now to FIG. 1, a functional diagram of the components of an identification device constructed in accordance with a preferred embodiment of the present invention is shown. The device includes a battery 2 that provides power to the electronics of the hand-held device. A microprocessor 4 is used to control the electronics and manage the functioning of the device. The microprocessor 4 communicates with a variety of biometric sensors 6, 8, 10 and 12 through a signal processing circuit 42. Although a wide variety of biometric sensors 12 may be used with the device of the present invention, the microprocessor 4 preferably relies upon a microphone 10, fingerprint sensor 6, and video camera 8 to receive biometric information concerning an individual. The processor 4 also controls a number of input/output ports 14, 16, 18, 20, 22, 24, 26, 28 and 30. More particularly, an audio generator 46 is used in conjunction with a speaker 14 to provide audible indications or instructions in the form or voice responses to a user of the device. An input/output controller 42 interfaces the processor 4 with a set of LED indicators 16 and a display 18 to provide visual indications and instructions to a user of the device. The input/output controller 42 also interfaces the processor 4 with a set of smart card contact points 22 that may be used to transfer information between the device and a smart card in accordance with standard smart card formatting. A standard USB interface 24 and infrared data port 26 allow the processor 4 to communicate with other devices having similar input/output ports. Finally, a long range radio antenna 28 and a RFID proximity antenna 30 communicate with the processor 4 through an associated radio frequency chip 32 and the input/output controller 44. The processor 4 communicates internally with an encryption engine 34, an audit engine 38, a smart chip 36 and a secure memory 40. The encryption engine 34 encodes outgoing information and decodes incoming information to help prevent unauthorized access to restricted information. The secure memory 40 includes ROM memory that contains static information needed to operate the device and RAM that can store application software that can be run on the device. The memory 40 is secure in that, even when in standby mode or awaiting authentication by the user or other instructions received through one of the device's communications channels, a diagnostic and monitoring program runs to guard against attempts to hack into the device's memory 40 either by physical penetration or logical probe. In the event security is compromised, the device is programmed to clear significant portions of the data stored in its memory 40 to render the device and data useless to an attacker.

The identification device is used by applying an input to one of the sensors 6, 8, 10 and 12. For example, a user can activate the device by placing a finger against the fingerprint sensor 6. The signal processor 42 and fingerprint sensor 6 detect the presence of the finger on the fingerprint sensor 6 and instruct the processor 4 to validate the sensor's 6 output. If the fingerprint sensor's 6 output corresponds to a fingerprint profile stored in the secure memory 40, the processor 4 produces an authorized and/or authentication output that indicates that the appropriate individual has placed their finger on the fingerprint sensor 6. If the fingerprint sensor's 6 output does not correspond to an authorized profile, the processor 4 communicates an output that indicates the user has not been authorized by the device.

The processor 4 can communicate the results of the biometric identification with remote terminals and stations through a number of communication outputs 14, 16, 18, 20, 22, 24, 26, 28 and 30. If another smart card is present, the processor 4 can transmit data to, and receive data from, the smart card through the smart card contact array 22 mounted on the device. When the contacts of the contact array 22 are electrically connected to the contacts of the remote smart card, the processor 4 can communicate with the smart card through the contacts 22 using established communication protocols stored in the smart chip 36. The speaker 14 and microphone 10 are used in conjunction with voice recognition software to receive voice commands from a user, communicate audible messages to the user and perform biometric identification processes. The infrared communication port 26 allows the processor 4 to communicate with personal data assistants, computers, printers, cameras and a plethora of additional electronic devices that utilize infrared communication channels.

In response to an affirmative biometric identification, the device may perform a number of authorization functions such as producing and communicating authentication signals. For example, an authorization code may be communicated from the device to an external machine such as a telephone, PDA or automated teller machine. The authorization code may be associated with an account or an individual such that the reception of the authorization code by the remote terminal accesses an account of the individual and allows the individual to debit or credit the account in conformance with a set of predetermined criteria. Alternatively, the authorization code may be used to establish a communication link with an outside device through the use of the infrared communications port 26. For example, if a customer wanted to access their e-mail account through a remote terminal, the device could communicate the authorization code and the card holder's information to the remote terminal. The remote terminal could then access and/or debit an account associated with the device or individual based upon the device's identification of the user and allow the user to access their e-mail. Alternatively, the individual could access confidential information such as medical records and receive an authenticated prescription from a health care provider that would then be transferred to a pharmacist along with an authenticated certificate that would allow the pharmacist to fill the individual's prescription without a paper prescription.

A timing function may be implemented by the processor 4 such that the authorization obtained through a biometric identification, such as by placing a finger on the fingerprint sensor 6, only last a predetermined amount of time, such as five minutes. This timing function insures that the authorized individual is in possession of the device substantially contemporaneously with the authorization of the individual and the corresponding production of the authentication signal.

The provision of a secure memory 40 in the device allows the device to be personalized without compromising the security or integrity of any registration or access information stored on the memory 40. Restricted access information may be stored in the secure memory 40. The secure nature of the memory 40 prevents users of the device and/or hackers from altering important identification information such as access codes and biometric profiles stored in the device. Updateable information that may be altered by the user or the processor may also be stored in the secure memory 40 through the use of the audit engine 38. This updateable information may include user information such as an authentication log that records the time and nature of each authorization and/or authentication performed by the card. The audit engine 38 allows an authorized and identified user or manager to access and audit the authentications performed by the device and the time they were performed by entering a password. The authentication log can be scrutinized when desired to monitor the actions of the device user or the attempted use of the device by an unauthorized user.

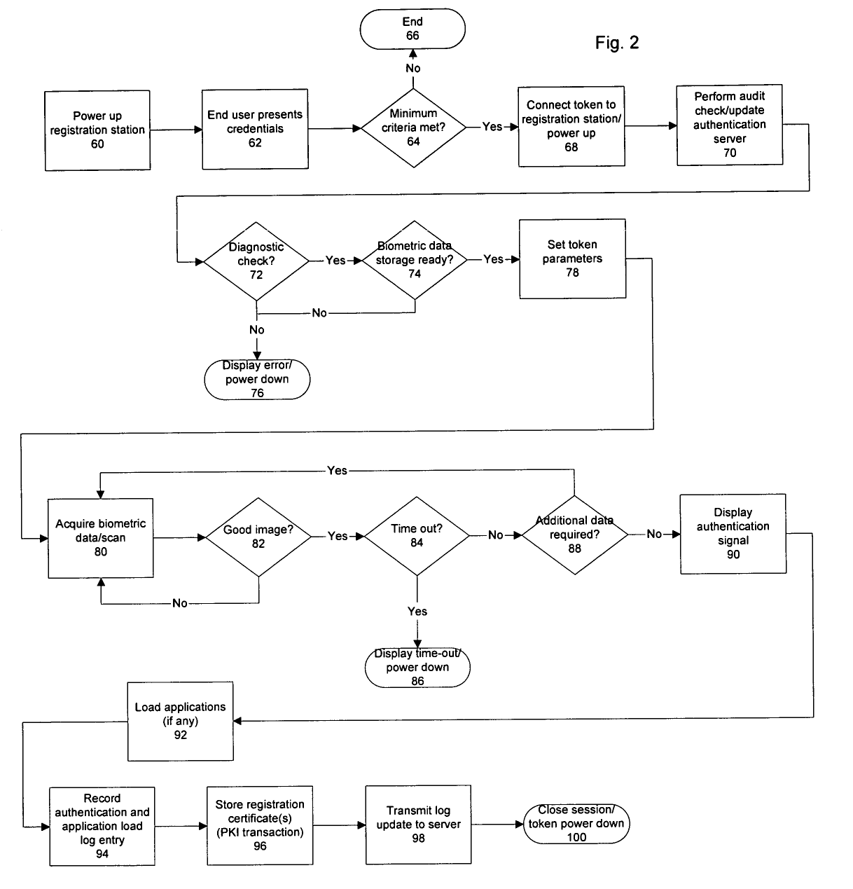

Referring now to FIG. 2, a flow chart of an embodiment of the present invention utilizing a preferred registration routine is shown. The registration process begins with the powering up of a registration station in block 60. This registration station may be an any time teller (ATM) machine, PDA, personal computer, telephone or swipe card reader as discussed with respect to FIG. 1. Once the registration station is on-line, the end user presents their credentials, in the form of a device or token constructed in accordance with the present invention, to the registration station in block 62. In block 64, the credentials are electronically examined to determine whether or not they meet certain minimum criteria. For example, the credentials may be interrogated through an infrared communication channel to determine whether or not they include a valid, active account number. If these minimum criteria are not satisfied, the method proceeds to block 66 where it ends. Thus, use of the registration station is limited to a predefined set of users holding valid access credentials. However, if these minimum criteria are satisfied, the method proceeds to block 68 wherein the token is powered up and an authorized communication channel between the token and registration station is established. In block 70, the information contained in the token is audited by the registration station and an authentication server is updated. The method then proceeds to block 72 wherein a diagnostic check of the token's electronics systems is performed. If the diagnostic test is passed, the token is interrogated to determine if its biometric data storage is ready to be used in an identification process as shown in block 74. If the token fails either the diagnostic test or the biometric data check, the method proceeds to block 76 wherein a error message is displayed to a user of the token and the token is powered down.

If the token is functional, the registration station sets a series of token parameters in block 78. These parameters instruct the token to obtain and provide the appropriate authentication information to the registration system. For example, if fingerprint authorization is required, the token parameters instruct the token to authenticate the individual's fingerprint. Alternatively, if voice print identification is required, the parameters may instruct the token to authenticate the individual's voice received from a microphone mounted on the token. Once the parameters are set, the token acquires biometric data from the card holder such as by scanning the card holder's fingerprint as shown in block 80. In block 82, the quality of the scanned image is evaluated. If the image is invalid, the method proceeds back to block 80 wherein a new image is scanned. In block 84, a time out condition is evaluated whereby the scanned biometric information is invalidated if a given amount of time has expired. As previously discussed, this time out feature prevents a stolen device from being utilized anytime except immediately after validation. If the time out condition is satisfied, the method proceeds to block 86 wherein the token powers down. If the time out condition is not satisfied, a processor in the token determines whether additional information is required in block 88. If more information is needed, the method proceeds back to block 80 wherein the additional information is acquired. If sufficient information has been acquired to properly identify the individual, the method proceeds to block 90 wherein an authentication signal is displayed and communicated to the registration station.

Once the user of the token has been authenticated, the authorized application is loaded or prepared as shown in block 92. The user then performs the desired transaction or calls the desired number depending upon the particular application used. The authentication and applications logs are updated in accordance with the actions of the token holder in block 94. In block 96, any registration certificates that are used to establish the validity of the initial stored biometric information, or are created as a result of the particular application such as a personal key identified PKI transaction, are stored on the token in its internal memory. In block 98, an updated log is sent to the server that is monitoring the use of the token. Finally, the registration process terminates in block 100 with the closing of the session and the powering down of the token.

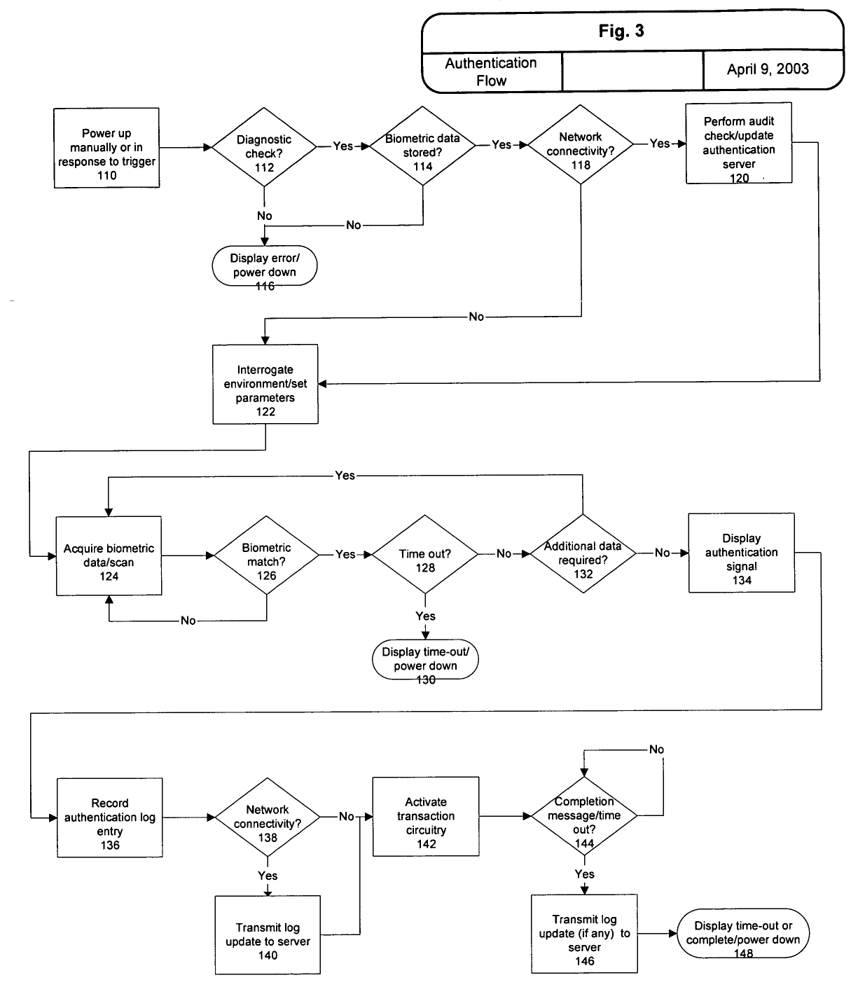

A preferred authentication process for an embodiment of the present invention is set forth in FIG. 3. The authentication process begins in block 110 with the powering up of the device or token in response to a trigger or a manual request. After power up, a diagnostic test is performed on the device to insure that all of its systems are functioning properly as set forth in block 112. If the diagnostic test fails in block 112, the process proceeds to block 116 wherein an error message is displayed and the card is powered down. Otherwise, the method proceeds to block 114 to determine if biometric data for making an identification is stored in the device. If not, the process loops back to block 116 wherein an error message is displayed and the card powers down. If biometric identification information is present, the card determines whether or not a communication link has been established with a network in block 118. If a network connection is established, an audit is performed to check and update the server and insure that any necessary accounts are active in block 120. If the device is not connected to a network or the device has passed the network audit, the method proceeds to block 122 wherein the device interrogates its environment to determine if any inputs need to be received and to set the appropriate parameters for receiving the inputs. After all parameters have been set, the preferred authentication method acquires biometric data from a scan or other such input in block 124. If the biometric data matches the biometric data stored in its memory, the method proceeds from block 126 to block 128 wherein a time out condition is monitored. If the biometric data is not a match, the method returns to block 124 wherein it attempts to acquire more biometric information. The method terminates by displaying a time out message and powering down if the time out condition is satisfied as set forth in block 130. Once the biometric information has been received, the authentication routine determines if any additional information is required as set forth in block 132. If additional data is required, the method proceeds back to block 134 wherein the device attempts to acquire the additional needed data. If additional data is not required, the method proceeds to block 134 wherein an authentication signal is displayed to the user and/or communicated to a remote device. In block 136, an authentication log is recorded and updated to reflect the latest actions of the device holder. If a communication channel is present between the device and a network in block 138, a log update is transmitted to the server as shown in block 140. If there is no network connection, the method proceeds to block 142 wherein transaction circuitry in the device is activated to perform the desired transaction. After the transaction has been completed, a transaction completion message is displayed and the time out condition is reviewed as set forth in block 144. Once the time out condition or transaction complete condition is satisfied, the method proceeds to block 146 wherein a final log update is sent to the server if possible. The method ends in block 148 with the displaying of a transaction complete and/or power off message as the token or card powers down.

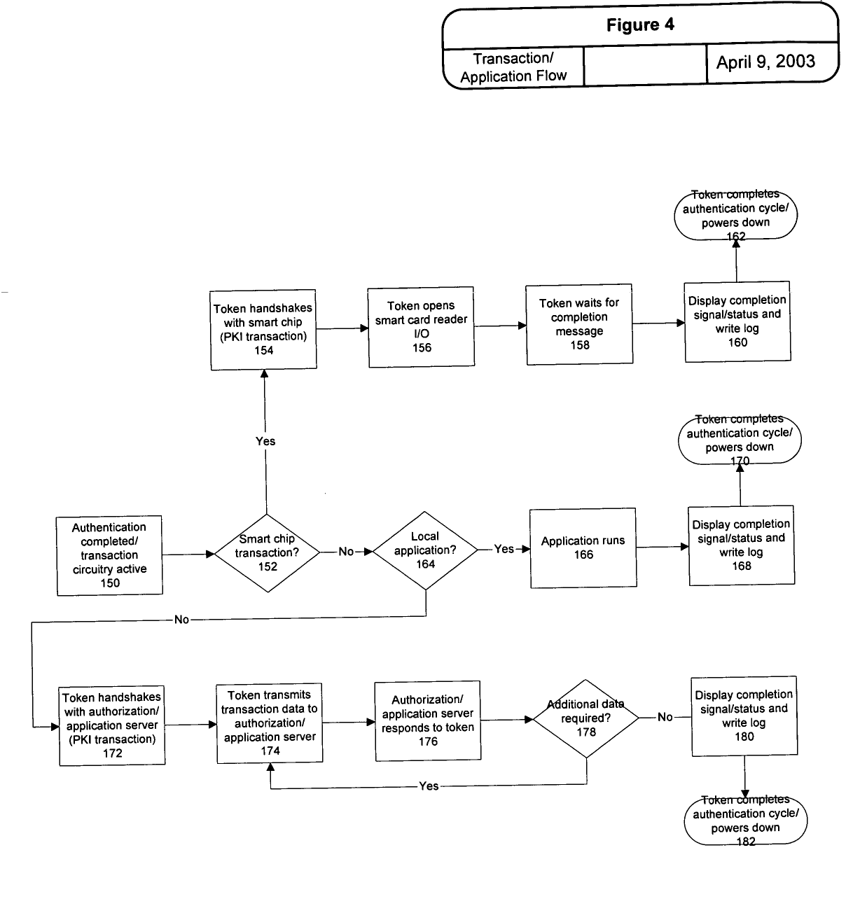

A more detailed description of the transactional processes performed by the self-authenticating device or token is set forth in FIG. 4. The transactional process begins when the authentication process has been finished and the transactional circuitry is activated as set forth in block 150. Once the transactional process has been initiated, the device evaluates whether or not the desired transaction is a smart chip transaction in block 152. If the transaction is a smart chip transaction, the method proceeds to block 154 wherein the token or card performs established smart chip handshakes with the detected smart chip. The token opens its smart card reader input/output in block 156 to allow it to send messages to, and receive messages from, the detected smart chip. In block 158, the token waits until all desired messages have sent to or received from the smart chip. Once the transaction is completed, a completion message is displayed and the transaction is recorded in a writable log in block 160. Finally, the token powers down upon completion of the transaction as shown in 162.

If, in block 152, it is determined that the token is not involved in a transaction with another smart chip, the token determines in block 164 whether or not the requested transaction is a local transaction performed by the token. If it is a local transaction, the token runs the requested application in block 166. The ability of the token to perform local applications is a significant benefit over the prior art that is accomplished through the provision of a local processor and memory in an identifying device. Such an application could be a calculator, video game or scheduling transaction performed on the token. In such a transaction, the token would function in a manner similar to a personal data assistant or PDA. In addition, the on-device authentication capability of the embodiment insures that access to these local applications can be limited to particular individuals and the appropriate associated accounts debited or credited accordingly. Once the application has run, a completion message is displayed and the status log updated in block 168. The token or device completes the authentication cycle and powers down in block 170.

If, in block 164, it is determined that a local transaction is not involved, the method proceeds to block 172 wherein the token exchanges handshake signals useful in performing a personal key identification transaction with the detected authorization/application server. After a communication channel with the remote application is established, the token transmits transactional data to the authorization/application server as set forth in block 174. In block 176, the application/authorization server responds to the token. If the response indicates that the application authorization server needs additional data from the token as set forth in block 178, the method loops back to block 174 wherein the token sends the additional requested data to the server. If no additional data is needed, a completion signal is displayed and the status and write logs are updated in block 180. The token completes the authentication cycle and powers down in block 182.

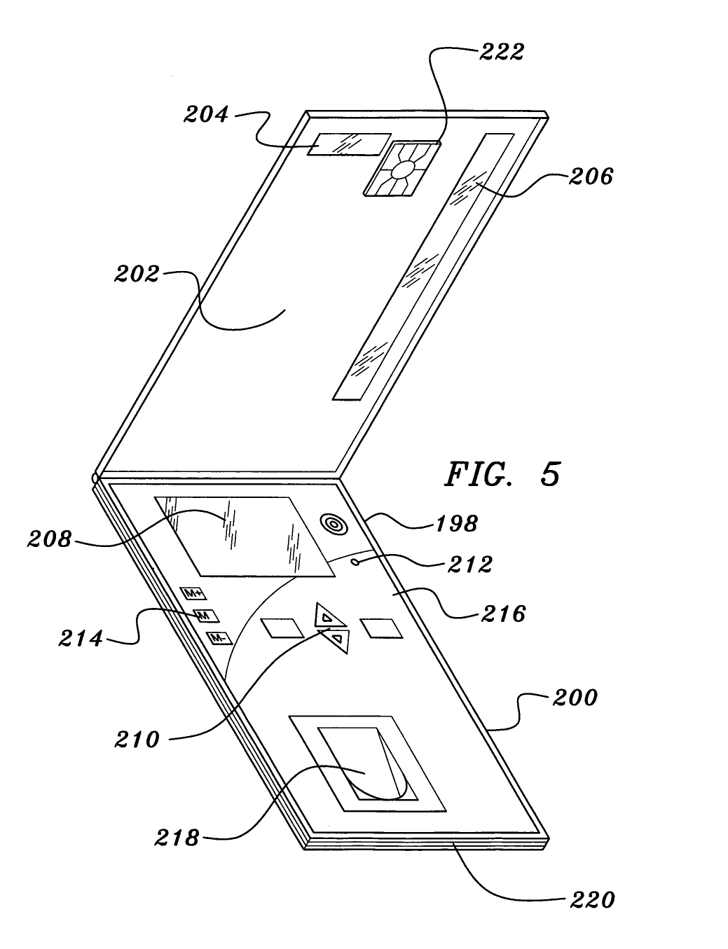

FIG. 5 is a pictorial representation of a preferred external configuration for an embodiment of the present invention. The embodiment consists of an electronics housing 200 rotatably attached to a flip cover 202. The provision of the electronics housing 200 allows the embodiment to contain all of the electronic components 220 necessary to support voice and fingerprint identification software and interfaces. These electronic components 220 preferably include a rechargeable battery, power supply, processor, secure memory, etc. as set forth in more detail above. A power switch 198 and associated indicator light are provided on the housing 200. The flip cover 202 preferably contains an embedded proximity type communication antenna (not shown) and two magnetic stripe emulators 204 and 206. The magnetic stripe emulator 204 positioned on the far end of the flip cover 202 is designed to be used with “swipe” type card readers while the magnetic stripe emulator 206 positioned on the side of the flip cover is designed to be used with “dip” type card readers. The provision of the magnetic stripe emulators 204 and 206 and the internal proximity antenna in the flip cover 202 allows the device to communicate with preexisting proximity or magnetic stripe type card readers that are currently used with a wide range of applications. A LCD display 208 is provided on the electronics housing 200 that allows the embodiment to communicate with a user. The display 208 preferably is capable of displaying text messages as well as color and black-and-white video images. Menu navigation and selection buttons 210 are provided that allow an individual to communicate instructions to the embodiment. Appropriate menus may be provided that allow the user to input text through the buttons 210. In a most preferred embodiment, a microphone/speaker 212 is utilized in conjunction with voice recognition software to allow the device to respond to voice commands from a user and convert spoken messages by the user into text files. This voice recognition software is also utilized to perform a voice identification process to authenticate individuals for various applications as discussed in more detail above. Indicator lights 214 are used to display common outputs such as “transaction completed” or “identity authenticated”.

A variety of communication devices are incorporated into the electronic housing 200 and flip cover 202. More particularly, USB and power input connectors 216 are provided on the side of the electronic housing 200 that allow the device to establish communications with other devices such as printers, PDAs and personal computers that have this capability. A proximity antenna is incorporated into the flip cover 202 such that messages may be sent to, and received, from proximity type devices utilized in applications such as parking garages and security systems. A set of smart card contacts 222 allow the device to communicate using the smart card format. The on-board power supply and processing capability of the embodiment allow the information coded on the magnetic stripes 204 and 206 to be altered as desired by the device holder or the device itself with proper authorization. Registration certificates saved on the stripes 204 and 206 or in a read-only memory that is incorporated into the device's electronics can be monitored by the device's processor to insure that access to any restricted data saved in the device's memory or encoded on the stripes 204 and 206 is limited such that the data is not altered by unauthorized individuals.

A fingerprint sensor 218 is provided on the electronics housing 200 to receive biometric information from an individual possessing the device. Although a fingerprint sensor 218 is shown on the embodiment of FIG. 5, in alternative embodiments the fingerprint sensor 218 could be replaced with a facial scanning camera, retinal scanning camera or DNA sensor. The fingerprint sensor 218 is used to obtain biometric data that is compared to a reference data base stored in the device's memory. Storing the reference data in the device itself limits access to the data and eliminates the need for big brother type data bases.

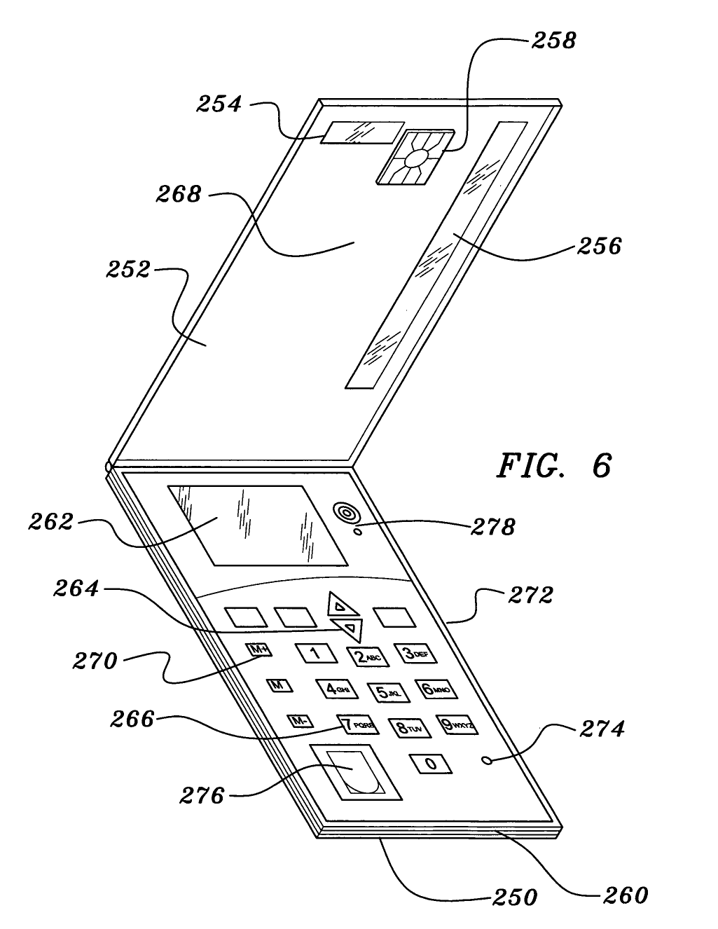

Yet another preferred embodiment of an external configuration of a device constructed in accordance with the present invention is set forth in FIG. 6. The device includes a housing 250 attached to a flip cover 252. The flip cover 252 has a magnetic stripe 254 for swipe type applications and a magnetic stripe 256 for dip type applications. A set of smart card contacts 258 are also provided on the flip cover 252. A proximity antenna is embedded in the flip top cover 252 that allows the device to communicate with other proximity antenna equipped devices. A camera 268 allows the device to create digital data that corresponds to visual biometric information such as facial features or retinal scans. The housing 250 contains the electronics 260 needed to operate the device. A USB port 272 is provided on the housing 250 such that the device can communicate data to devices operating in accordance with the USB format. The numerous input/output ports utilized by the device enable the device to communicate with one or more other devices to either send secure data or transmit proof of the user's authentication. This capability can be used effectively in dual-key/multi-key access or activation of equipment, such as military fire-control, as well as providing proof of several users' participation in assembling and/or securely transmitting information, such as patient and insurance coverage identification and the presentation of electronic prescriptions “signed” by the physician in healthcare applications. The ability of the device to communicate with a wide variety of different types of devices using a variety of different formats represent a significant advancement over the prior art.

A speaker/microphone 274 is provided on the housing that allows the device to send and receive audible information. The microphone/speaker 274 allows the device to provide identity authentication by means of a voice match. In addition, the device can respond to voice commands with a basic natural vocabulary that the user can expand by training the device with each command before and during use. This provides a significant and flexible alternative for user input and data entry, especially for users with certain disabilities. A fingerprint sensor 276 is provided such that fingerprint identifications can be performed by the device as discussed in more detail above. A display 262 mounted on the housing 250 is used to display information to a user of the device. Status and indicator lights 270 provide a user visual indications of commonly performed operations. A set of menu navigation keys 264 and an alphanumeric keypad 266 in conjunction with the display 262 and indicator lights 270 further facilitate communicate between a user and the device. A power switch 278 is used to turned the device on and off.

In addition to the above discussed features, the present invention disclosure also includes the subject matter contained in the appended claims. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

1. A portable device for authenticating an individual's identity and authorizing use of limited access accounts, said portable device comprising:
a magnetic strip that is readable by a standard swipe card reader;
input communication means for receiving a request for an authentication signal from a remote terminal;
a power supply for providing power to the device;
a biometric sensor for detecting biometric information and producing a sensed biometric profile in a response to a received request for an authentication signal;
a memory for storing a biometric profile corresponding to an individual;
a processor for comparing the sensed biometric profile with the stored biometric profile and producing an authentication signal; and
output communication means for communicating the authentication signal to the remote terminal.

2. The portable device of claim 1 wherein the output communication means further comprises an infrared communication port.

3. The portable device of claim 1 further comprising a proximity antenna for sending messages to, and receiving messages from, another proximity antenna.

4. The portable device of claim 1 further comprising a microphone for receiving audible signals and voice recognition software for comparing said audible signals and with stored individual voice profiles.

5. The portable device of claim 1 further comprising a keyboard that allows a user to enter text into the device.

6. The portable device of claim 1 further comprising a speaker that allows the processor to produce voice responses.

7. The portable device of claim 1 further comprising magnetic strip writing means that allow the processor to alter information contained on the magnetic strip.

8. The portable device of claim 1 wherein said memory contains certification information that can be examined by a remote terminal to determine if the device corresponds to an authorized account.

9. The portable device of claim 1 wherein the biometric sensor further comprises a fingerprint detector and the processor and memory further comprise fingerprint recognition software for determining if a sensed fingerprint matches a stored biometric profile.

10. The portable device of claim 1 wherein the portable device has a protrusion that is adapted to engage a swipe card reader.

11. An electronic data assistant, said electronic data assistant comprising:
a card swipe interface that allows stored data to be communicated to a magnetic card reader;
a data input that allows said electronic data assistant to receive personal identifying data from a remote source;
a memory for storing personal identification information related to a particular individual;
a processor for comparing said personal identifying data from said remote source to said stored personal identification information and producing an authentication signal based upon said comparison; and
a data output for communicating said authentication signal to a remote source.

12. The electronic data assistant of claim 11 wherein said data input further comprises a fingerprint sensor that produces a fingerprint profile as said personal identifying data in response to an individual placing their finger against the fingerprint sensor.

13. The electronic data assistant of claim 11 wherein said data input further comprises a microphone that produces an electronic data signal in response to received audio signals and voice recognition software processes said electronic data signal to produce said personal identifying data.

14. The electronic data assistant of claim 11 wherein said memory further comprises a random access memory that can be modified by said processor and a read only memory that can not be modified by said processor.

15. The electronic data assistant of claim 11 wherein said data output further comprises an infrared communication port.

16. The electronic data assistant of claim 11 further comprising a proximity antenna.

17. The electronic data assistant of claim 11 further comprising a microphone for receiving audio inputs and voice recognition software for processing said received audio inputs.

18. The electronic data assistant of claim 11 further comprising a display for communicating with a user and a keyboard for allowing said user to communicate with said electronic data assistant.

19. The electronic data assistant of claim 11 wherein the card swipe interface further comprises a blade-shaped protrusion adapted to be accepted by a card reader.

20. A method of authorizing an individual to access an account or perform a transaction said method comprising:
detecting a communication center's request for an identification;
prompting an individual to respond to said request for an identification by providing biometric information;
receiving said biometric information from said user;
processing said biometric information to determine if said biometric information corresponds to a biometric profile;
producing an authentication signal; and
communicating said authentication signal to said communication center in response to receiving said request for an identification.

21. The method of claim 20 wherein the step of receiving biometric information from said user further comprises receiving a representation of said user's fingerprint.

22. The method of claim 20 wherein the step of receiving biometric information from said user further comprises receiving a voice sample from said user.

23. The method of claim 20 wherein the step of processing said biometric information to determine if said biometric information corresponds to a biometric profile further comprises comparing the biometric information to a biometric profile stored on a device carried by the individual.
